(19) United States
(12) Patent Application Publication
(10) Pub. No.: US 2008/0314853 A1
(43) Pub. Date: Dec. 25, 2008

(54) CLIMBING AND SUPPORT SYSTEM FOR PUMPING TOWER

(75) Inventors: Walter N. Knigge, Racine, WI (US); C. William Carbeau, Naples, FL (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: PUTZMEISTER, INC., Sturtevant, WI (US)

(21) Appl. No.: 11/767,736

(22) Filed: Jun. 25, 2007

(51) Int. Cl. B66C 23/00

(52) U.S. Cl. 212/179

(57) ABSTRACT

A climbing and support system is provided for a support structure having at least one vertical support member extending through at least one opening in a floor structure. The climbing and support system includes a ladder assembly attached to the vertical support member. A climbing cylinder arrangement and a locking bar structure are engageable with the ladder assembly, and are pivotally supported outside the vertical support member on the floor structure for vertically moving and supporting the support structure relative to the floor structure.

### FIELD OF THE INVENTION

The present invention relates generally to a climbing and support system that allows a tower-supported concrete placing boom to be selectively raised and supported at different vertical positions relative to the floor structure development of a building under construction.

### BACKGROUND OF THE INVENTION

Currently, concrete placing booms are used at large work sites, such as during the construction of a multi-floor building, for placing concrete in hard to access locations. Typically, the concrete placing boom is mounted to a support structure, such as a pumping tower, that passes through the developing floor structure of a building, and extends above a working surface such that concrete can be supplied to the floor being constructed. The concrete placing boom can be removed from one pumping tower and lifted, such as by a crane, to another pumping tower, if desired.

The pumping tower holding the concrete placing boom can be supported by the ground floor structure and/or by the floor structures through which the pumping tower passes. In the latter situation, there needs to be a mechanism by which the floor structures support the pumping tower after the pumping tower is raised by either an on-site crane or a specially designed climbing system that hydraulically jacks the tower up using the floor structures as the support base.

Raising of a pumping tower by use of a crane can present several drawbacks. Inasmuch as the cost of renting a crane can be thousands of dollars a month, inclusive of the cost of operators and insurance, it should be appreciated that the use of a crane for lifting the pumping tower becomes very costly.

Inefficiencies are inherent in raising a pumping tower with a crane. The concrete placing boom is typically removed and set aside while the pumping tower is raised. Afterward, the boom must be lifted and reinstalled. The entire time the crane is supporting the placing boom during re-installation, it is not available for any other work. The crane operator may not be familiar with concrete placing booms or towers, necessitating time wasted with explanations and directions by the concrete placing boom operator. Coordination is needed between the crane operator, placing boom crew, and construction crew. This often results in one crew having to wait until the crane operator finishes serving the other crew before they can resume work.

Other problems encountered by use of a crane are inherent in the crane design and the placement of the concrete boom at the top of the pumping tower. For example, even if an on-site crane is available at the building site, the crane may not have the proper lifting capacity to pick up and raise the pumping tower. In addition, use of a crane may necessitate the removal of the concrete placing boom from the tower before lifting of the pumping tower can occur.

As an alternative to using a lifting crane, self-climbing pumping towers are known that employ hydraulic cylinders and other associated structures to incrementally jack the pumping tower up using the floor structures as a support base without requiring removal of the concrete placing boom.

One system previously in common use employed a hydraulic cylinder connected to a specially equipped lower mast section, with an additional cross piece connected to the cylinder and engaged in a pair of opposed ladder-like columns extending from the lower floors to the top of the building along the tower, within the shaft of the floor openings. Dogs of this lifting structure would engage on rungs or slots of these laddered devices moving up the ladders and engaging new slots as the lifting cylinder was actuated.

In another lifting system which has been widely used, jacks were positioned on a floor of the building structure, with smooth lifting rods depending downwardly from the jacks to a connecting device engageable with a specially equipped mast section. A device associated with the jacks and having teeth would grasp each rod for the lifting stroke. The specially equipped mast section, normally located at the bottom of the tower, had holes for receiving the connecting device, which extended laterally through the mast. The tower was supported entirely by the rods and connecting device while being lifted by a series of jacking strokes. For supporting the tower after it was lifted to the new elevation, this ladder system utilized I-beams inserted horizontally through a mast section. The jacks lowered the crane a short distance to rest the I-beam on a building floor. For these prior lifting systems, it is important to provide not only support for the vertical load of the tower, but also for the lateral load or side loading to prevent the crane from tipping and to accept twisting forces induced by the boom.

Despite these prior art arrangements, there remains a need to provide a simplified, light-weight yet effective climbing and support system for raising and securing a vertically movable tower to a floor structure of a building in a manner which decreases time and effort. Further, there is a need to provide a climbing and support system that is substantially easier and more economical to install and operate on a pumping tower and desired floor structure of a building under construction. Also, there is a need for a system where one operator can perform both the raising and locking operations from one location to reduce the time required and eliminate the need for a second operator to perform one of the tasks. Additionally, there is a need to provide a climbing and support system that is commonly operated by the power supplied to the concrete placing boom at the top of the pumping tower.

### SUMMARY OF THE INVENTION

The present invention relates to a climbing and support system for a support structure having at least one vertical support member extending through at least one opening in the floor structure of a building. The climbing and support system includes a ladder assembly attached to the vertical support member. A climbing cylinder arrangement and a locking bar structure are engagable with the ladder assembly, and are pivotally supported outside the vertical support member on the floor structure for vertically moving and supporting the support structure relative to the floor structure.

The ladder assembly is secured to only one side of the support structure. The support structure is preferably a tower provided with a concrete placing boom at an upper end thereof. The ladder assembly includes a catch plate structure positioned against a front wall of the vertical support member. The ladder assembly partially surrounds each of a pair of vertical support members on the one side of the support structure. Each of the ladder assemblies is engageable with one climbing cylinder arrangement and one locking bar structure. The climbing cylinder arrangement and the locking bar structure are pivotally supported on the floor structure by a shared floor bracket assembly that does not require additional fastening structure between the floor bracket assembly and the floor structure. The climbing cylinder arrangement and the locking bar structure are movable from one floor structure to a subsequently formed floor structure surrounding the support structure. The climbing structure arrangement and the locking bar structure are supported for independent pivoting movement relative to the floor structure along parallel horizontal axis.

In another aspect of the invention, a climbing and support system is provided for moving and supporting a support tower having a plurality of vertical support members relative to a floor structure of a building. The support tower extends through at least one opening in the floor structure. The climbing and support system includes an elongated ladder assembly extending along substantially an entire length of each of a pair of the vertical support members on one side of the support tower. A climbing cylinder arrangement and a locking bar structure are engageable with each ladder assembly and are pivotally secured outside each of the pair of vertical support members to a floor bracket assembly removably supported on the floor structure for vertically moving and supporting the support tower relative to the floor structure. The locking bar structure is located between the climbing cylinder arrangement and the elongated ladder assembly.

The ladder assembly includes a number of serially connected ladder sections, each ladder section having a pair of spaced apart side structures. Each side structure includes vertical members and horizontal members that extend along side walls of the vertical support members. Each ladder section is provided with a series of vertically aligned catch plates that are variously engagable with the climbing cylinder arrangement and the locking bar structure. The floor bracket assembly includes a pair of floor brackets for pivotally mounting the climbing cylinder arrangement and the locking bar structure. The floor brackets are interconnected by an elongated spaced tube. The tube depends into the floor structure opening and engages a wall forming the floor structure opening. Each climbing cylinder arrangement includes a hydraulic cylinder having a rod end provided with a lifting hook pivotally secured thereto. The lift hook has a finger engageable with a rear portion of the catch plates and a force transmitting structure engageable with a front portion of the catch plates. The force transmitting structure is preferably a V-shaped gusset having a planar face plate attached thereto. Actuation of the climbing cylinder arrangement against certain of the catch plates will cause the locking bar structure to freely engage and disengage other of the catch plates. The climbing cylinder arrangement, the locking bar structure and the floor bracket assembly are movable from one floor to a subsequently formed floor structure surrounding the support tower. The climbing cylinders, locking bar structures and floor bracket assemblies are lightweight and portable to facilitate movement from one floor to another within the floor structure of the building. The ladder assemblies are removable and may be removed, added to, or moved to another tower at any time.

The invention further contemplates a method for self-jacking and securing a support tower relative to a floor structure of a building. The support tower extends through at least one opening in the floor structure. The method includes the steps of a) providing an elongated ladder assembly extending along substantially an entire length of at least one vertical support member on one side of the support tower, the ladder assembly having a number of catch structures provided thereon; b) pivotally mounting a climbing cylinder arrangement and a locking bar structure engageable with the catch structures on each ladder assembly outside the vertical support member to a floor bracket assembly removably supported on the floor structure, the locking bar structure being located between the climbing cylinder arrangement and the ladder assembly; and c) selectively actuating the climbing cylinder arrangement to engage the cylinder arrangement with certain catch structures on the ladder assemblies and push the support tower upwardly enabling the locking bar structures to engage other of the catch structures on the ladder assemblies and support the tower at various vertical positions relative to the floor structure.

### BRIEF DESCRIPTION OF THE DRAWINGS

The drawings illustrate the best mode presently contemplated of carrying out the invention. In the drawings:

FIG. 1 is a perspective view of a vertically movable tower-supported concrete placing boom movable along and securable to the floor structure of a building by means of a climbing and support system;

FIGS. 2-3 are enlarged views of a lower portion of FIG. 1, illustrating the climbing and support system in different operating phases;

FIG. 4 is a partial section of view taken on line 4-4 of FIG. 3; and

FIG. 5 is a partial section of view taken on line 5-5 of FIG. 4.

### DETAILED DESCRIPTION OF THE PRESENT INVENTION

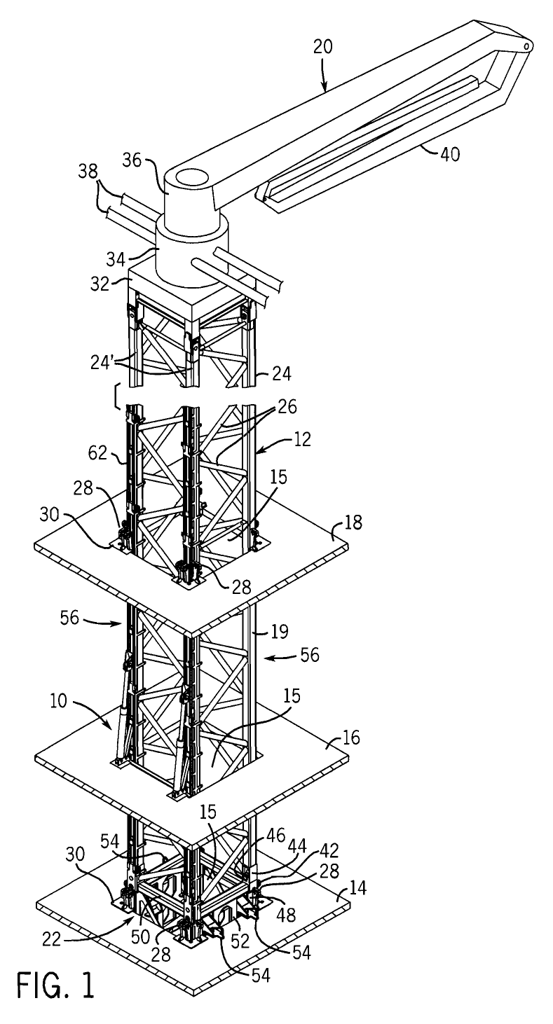

FIGS. 1-3 illustrate a climbing and support system 10 for selectively moving and supportably coupling a vertically movable support structure or pumping tower 12 relative to a floor structure of a building under construction. As is known, the pumping tower 12 passes through an opening 15 in a floor structure 14 at a first level, and extends upwardly through aligned openings 15 in subsequently completed upper floor structures such as shown in 16 and 18. As construction of the building progresses and new floor structures are added by pouring concrete, the entire pumping structure 12 is raised or jumped upwardly and secured to an upper floor structure by means of the climbing and support system 10 embodying the present invention.

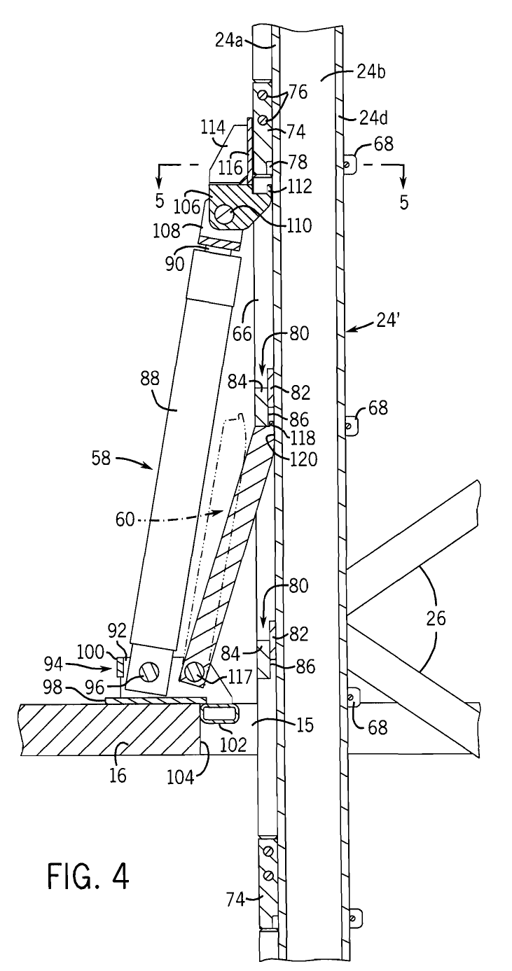

The pumping tower 12 includes a lattice tower 19 formed from one or more joined sections having a concrete placing boom 20 rotatably attached at an upper end, and a base or support framework 22 fixedly attached to the lower end. It should be understood that lattice tower 19 could be replaced by a support mast having a closed outer wall, if desired. The lattice tower 19 is an elongated support structure having four spaced apart vertical corner columns 24, 24′ interconnected by a series of diagonal braces 26 throughout the length of the structure. Each corner column 24, 24′ has a front wall 24a, side walls 24b, 24c and a rear wall 24d as seen in FIG. 5. The corner columns 24, 24′ have outer engagement surfaces that are frictionally engageable with wedges 28 as the pumping tower 12 is supported at each floor structure 14 and 18. The wedges 28 are typically provided in pairs adjacent each corner of the floor opening 15, and are removably installed in slots formed in a plate 30 on floor structures 14 and 18. The wedges 28 provide stability so that the pumping tower 12 does not sway horizontally.

The upper end of the lattice tower 19 has a platform 32 provided with an adapter 34 for receiving a mounting block 36 of the concrete placing boom 20. The adapter 34 has an internal driving mechanism including a pinion (not shown) that is removably coupled to the mounting block 36, and is rotated about a vertical axis via a pair of toothed racks 38. Such tower adapter and boom mounting block coupling is more fully described in U.S. Pat. No. 6,675,822 issued Jan. 13, 2004. The mounting block 36 on the concrete placing boom is secured to an extendable and retractable arm assembly 40 for distributing concrete at the building site. Concrete is supplied through suitable delivery lines that run down the pumping tower 12 from the adapter 34 and mounting block 36 to a supply and pumping arrangement at a lower level.

The lower end of the lattice tower 19 is secured to connectors 42 at each upper corner of the support framework 22. The connectors 42 are bifurcated to receive complimentary-shaped feet 44 of the lattice tower 19, and then suitably anchored by pins 46 passing through the feet 44 and the connectors 42. The support framework 22 includes four spaced apart vertical legs 48 aligned with corner column 24, 24′ and connected together by upper cross members 50 and lower cross members (not shown). Support tower 22 further includes a vertical rack 52 on opposite sides thereof flanked by a pair of freely swingable support brackets 54 that are pivotally mounted relative to the legs 48 and the rack 52. As more fully described in co-pending U.S. patent application Ser. No. 11/621,733 filed Jan. 10, 2007, the support brackets 54 permit a highly effective support coupling of the pumping tower 12 to a floor structure, shown here at floor structure 14, or to other floor structures upon raising of pumping tower 12. It should be understood that an alternative support device other than support brackets 54 may be utilized to anchor the tower 19 during raising thereof.

The climbing and support system 10 is generally comprised of an elongated ladder assembly 56, a climbing cylinder arrangement 58 and a locking bar structure 60.

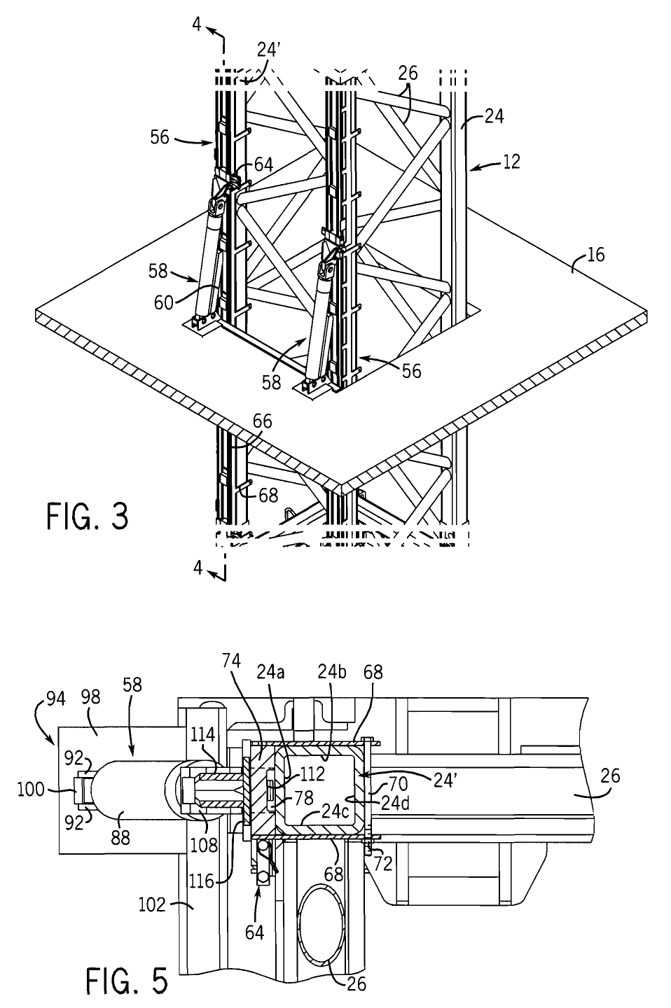

The ladder assembly 56 partially surrounds and extends substantially along the length of each of the two vertical columns 24′ of the pumping tower 12 on one side thereof. Each ladder assembly 56 includes a number of serially connected ladder sections 62 that are removably coupled together by retaining devices 64. The ladder sections 62 have a pair of spaced apart side structures provided with vertical members 66 and horizontal members 68 that extend along the side walls 24b, 24c of the vertical columns 24′. Certain of the horizontal members 68 are connected at their rearward ends by threaded pins 70 that run along the rearward walls 24d of vertical columns 24′ and are secured by nuts 72. The vertical members 66 project forwardly of the front walls 24a of vertical columns 24′, and are joined by primary catch plates 74 that engage the front walls 24a of vertical columns 24′. The primary catch plates 74 are secured to the retaining devices 64 by pins 76 as seen in FIG. 4. Bottom rear center portions of the primary catch plate 74 are formed with recesses 78, the walls of which act as engagement surfaces during a tower raising process.

Each ladder section 62 also includes a pair of vertically spaced apart, secondary catch plates 80 that are positioned between the vertical members 66 and are vertically aligned with primary catch plates 74. In the embodiment shown in FIG. 4, the secondary catch plates 80 are formed from two plates 82, 84 welded together, but it should be understood that these two plates could be an integral one-piece construction. The secondary catch plates 80 are also formed at their lower rearward portions with recesses 86 that serve as further engagement surfaces during a tower raising process. The primary and secondary catch plates 74, 80 are rung-like members of the ladder sections 62 that are vertically spaced apart substantially equidistantly for engagement by climbing cylinder arrangement 58 and locking bar structure 60.

Each ladder assembly 56 is provided with one climbing cylinder arrangement 58 and one locking bar structure 60 that are removably positioned together upon a floor structure, such as shown in 16, that surrounds pumping tower 12. Each climbing cylinder arrangement 58 typically takes the form of a hydraulic cylinder having a casing 88 and a rod 90 telescopically slidable into and out of the casing 88 as is well known. The cylinders provide the lifting forces required to selectively raise the pumping tower 12 as further floor structures are formed. Actuation of the cylinder is made possible by control of the hydraulic fluid which is commonly supplied to the concrete placing boom 20 by hoses and controls (not shown). Lower ends of the casing 88 are pivotally secured to upstanding walls 92 of removably positioned floor brackets 94 by pivot pins 96. The walls 92 rise upwardly from floor plates 98 that rest upon a respective floor structure 16, and are joined together by a connector 100. Connector 100 is actually a stop to prevent the cylinder from tipping over when it is not engaged in the ladder assembly 56. The floor plates 98 are rigidly connected together by an elongated spacer tube 102 which is placed against a wall 104 forming one side of floor opening 15. Spacer tube 102 prevents the pumping tower 12 from coming too close to floor wall 104 during raising operations by creating a loading in the opposite direction. It should be understood that the cylinder arrangements 58, the locking bar structure 60, the floor brackets 94 and the tube 102 are firmly yet removably supported on the floor structure 16 without the need for any additional screws, clamps or other extraneous fastening structure.

Upper ends of the rods 90 are provided with lift hooks 106 that are pivotally secured between bifurcated brackets 108 by pins 110. The lift hooks 106 have upwardly extending fingers 112 that are received in the recesses 78 or 86. Top surfaces of the lift hooks 106 are joined to V-shaped gussets 114 that are provided with face plates 116 at a rear portion thereof. Lower ends of the locking bar structure 60 are pivotally connected between the walls 92 of floor brackets 94 by pivot pins 117 so that locking bar structures 60 are positioned between the cylinder arrangements 58 and the ladder assemblies 56. It should be seen that the lower ends of the cylinder arrangements 58 and the locking bar structures 60 are pivoted about a pair of horizontal axes defined by pivot pins 96 and 117. Upper ends of the locking bar structure 60 are formed with curved surfaces 120 that engage the front walls 24a of vertical columns 24′ and are further formed with upwardly extending fingers 118 that are received in the recesses 78 or 86.

As seen in FIG. 1, use of the climbing and support system 10 is preceded by installation of the ladder assemblies 56 on the vertical columns 24′ on one side only of the pumping tower 12, and formation of the surrounding floor structures 14, 16, 18. The climbing and support structure 10 comprised of cylinder arrangements 58, locking bar structures 60, floor brackets 94 and interconnected spacer tube 102, is installed on floor structure 16 intermediate the floor structures 14 and 18.

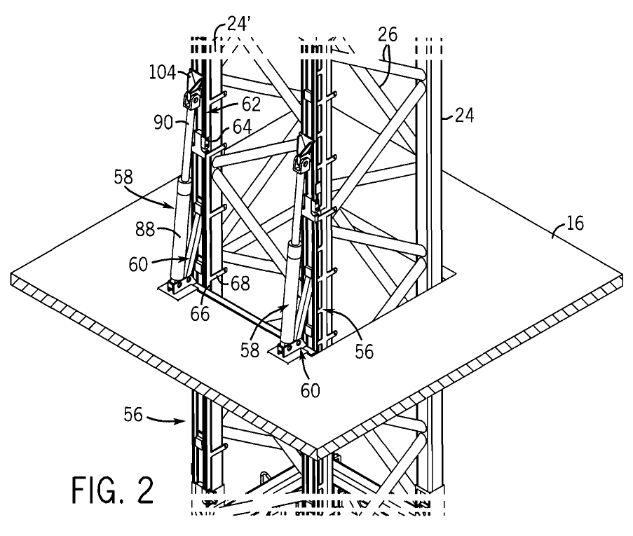

Initially, the fingers 112 of the cylinder lift hooks 106 are placed below catch plates 74 and against the front walls 24a of vertical columns 24′ between the vertical members 66 of the ladder sections 62. Fingers 118 of the locking bar structures 60 rest outside the plates 86. In their first lifts, cylinder rods 90 are extended approximately one half stroke so as to enable the lifting hooks 106 to engage catch plates 74. This will slightly raise pumping tower 12 so that fingers 118 of the locking bar structures 60 will ride past the bottom of plates 80 and become positively engaged against the walls of recesses 86. Once the locking bar structures 60 are further supporting the pumping tower 12, the rods 90 are retracted to disengage the lifting hooks 106 from catch plates 74. Rods 90 are then extended to their full strokes (about one half meter) until lift hooks 106 engage catch plates 84 as shown in FIGS. 2 and 4.

During engagement of the lift hooks 106 with the ladder assemblies 56, the face plates 116 slide over the front surfaces of catch plates 74 or 84. Pushing forces at the top of the cylinder arrangements 58 are distributed by the gussets 114 to the face plates 116, the bottom ends of which contact the top of lift hooks 106. Once the climbing and support system 10 is set as shown in FIG. 1, the pumping tower 12 is supported at its lower end by support brackets 54 and is laterally stabilized by wedges 28 secured at corners of the four vertical columns 24, 24′ on floor structures 14 and 18. The climbing and support system 10 may be re-installed at a subsequent floor structure for future raising of tower 12.

When it is desired to raise pumping tower 12, generally at least two floors have been formed above the floor structure equipped with the climbing and support system 10. FIGS. 3 and 4 depict the start of the raising of a pumping tower 12 from an intermediate floor structure 16. Here, rods have been retracted from their position shown in FIG. 2 so that the lift hooks 106 are placed slightly below catch plates 74. Now, rods 90 are extended so that the lift hooks 106 engage catch plates 74 and jack the pumping tower 12 upwardly. This causes the locking bar structures 60 to disengage from the upper pair of catch plates 84 and move to the phantom position shown in FIG. 4. The stroke length of the rods 90 is such that the locking bar structures 60 will then engage the lower pair of catch plates 84. This process is repeated until the pumping tower has been suitably positioned at a subsequent floor structure, supported at its lower end by support brackets 54. During raising of the pumping tower 12, vertical columns 24 opposite the climbing and support system 10 may slide permissibly against the wedge bracket 30 opposite wall 104.

The present invention provides a climbing and support system 10 which improves over existing systems used in raising and securing self-climbing pumping towers 12. The unique combination of the ladder assemblies 56, climbing cylinder arrangements 58 and locking bar structures 60 need only be used on one side of the pumping tower 12 which makes the system light-weight and more economical. This also allows one operator to perform both the raising and locking operations from one location. Further efficiency is obtained by using the hydraulic fluid supply of the concrete placing boom 20 to actuate the cylinder arrangements 58. The system 10 is designed to provide significant upward forces which will minimize twisting and lateral bending of the pumping tower as it is raised.

While the invention has been described with reference to a preferred embodiment, those skilled in the art will appreciate that certain substitutions, alterations and omissions may be made without departing from the spirit thereof. For example, a contemplated variation would involve the elimination of support brackets 54, relying on a second assembly of floor bracket 94 and locking bars 60. Accordingly, the foregoing description is meant to be exemplary only and should not be deemed limitative on the scope of the invention set forth with the following claims.

We claim:

1. A climbing and support system for a support structure having at least one vertical support member extending through at least one opening in the floor structure of a building, the climbing and support system comprising:
a ladder assembly attached to the vertical support member; and
a climbing cylinder arrangement and a locking bar structure engageable with the ladder assembly, and pivotally supported outside the vertical support member on the floor structure for vertically moving and supporting the support structure relative to the floor structure.

2. The system of claim 1, wherein the ladder assembly is secured to only one side of the support structure.

3. The system of claim 1, wherein the support structure is a tower provided with a concrete placing boom at an upper end thereof.

4. The system of claim 1, wherein the ladder assembly includes a catch plate structure positioned against a front wall of the vertical support member.

5. The system of claim 2, wherein the ladder assembly partially surrounds each of a pair of vertical support members on the one side of the support structure.

6. The system of claim 5, wherein each ladder assembly is engageable with one climbing cylinder arrangement and one locking bar structure.

7. The system of claim 1, wherein the climbing cylinder arrangement and the locking bar structure are pivotally supported on the floor structure by a floor bracket assembly that does not require additional fastening structure between the floor bracket assembly and the floor structure.

8. The system of claim 1, wherein the climbing cylinder arrangement and the locking bar structure are movable from one floor structure to a subsequently formed floor structure surrounding the support structure.

9. The system of claim 1, wherein the climbing cylinder arrangement and the locking bar structure are supported for independent pivoting movement relative to the floor structure along parallel horizontal axes.

10. A climbing and support system for moving and supporting a support tower having a plurality of vertical support members relative to a floor structure of a building, the support tower extending through at least one opening in the floor structure, the climbing and support system comprising:
an elongated ladder assembly extending along substantially an entire length of each of a pair of the vertical support members on one side of the support tower; and
a climbing cylinder arrangement and a locking bar structure engageable with each ladder assembly and pivotally secured outside each of the pair of vertical support members to a floor bracket assembly removably supported on the floor structure for vertically moving and supporting the support tower relative to the floor structure, the locking bar structure being located between the climbing cylinder arrangement and the elongated ladder assembly.

11. The system of claim 10, wherein the ladder assembly includes a number of serially connected ladder sections, each ladder section having a pair of spaced apart side structures.

12. The system of claim 11, wherein each side structure includes vertical members and horizontal members that extend along side walls of the vertical support members.

13. The system of claim 11, wherein each ladder section is provided with a series of vertically aligned catch plates that are variously engageable with the climbing cylinder arrangement and the locking bar structure.

14. The system of claim 10, wherein the floor bracket assembly includes a pair of floor brackets for pivotally mounting the climbing cylinder arrangement and the locking bar structure, the floor brackets being interconnected by an elongated spacer tube.

15. The system of claim 14, wherein the tube depends into the floor structure opening and engages a wall forming the floor structure opening.

16. The system of claim 15, wherein each climbing cylinder arrangement includes a hydraulic cylinder having a rod end provided with a lifting hook pivotally secured thereto, the lift hook having a finger engageable with a rear portion of the catch plates and a force transmitting structure engageable with a front portion of the catch plates.

17. The system of claim 16, wherein the force transmitting structure is a V-shaped gusset having a planar face plate attached thereto.

18. The system of claim 13, wherein actuation of the climbing cylinder arrangement against certain of the catch plates will cause the locking bar structure to freely engage and disengage other of the catch plates.

19. The system of claim 10, wherein the climbing cylinder arrangement, the locking bar structure and the floor bracket assembly are movable from one floor structure to a subsequently formed floor structure surrounded by the support tower.

20. A method for self-jacking and securing a support tower relative to a floor structure of a building, the support tower extending through at least one opening in the floor structure, the method comprising the steps of:
a) providing an elongated ladder assembly extending along substantially an entire length of at least one vertical support member on one side of the support tower, the ladder assembly having a number of catch structures provided thereon;
b) pivotally mounting a climbing cylinder arrangement and a locking bar structure engageable with the catch structures on each ladder assembly outside the vertical support member to a floor bracket assembly removably supported on the floor structure, the locking bar structure being located between the climbing cylinder arrangement and the ladder assembly; and
c) selectively actuating the climbing cylinder arrangement to engage the cylinder arrangement with certain of the catch structures on the ladder assemblies and push the support tower upwardly enabling the locking bar structures to engage other of the catch structures on the ladder assemblies and support the tower at various vertical positions relative to the floor structure.
